(19) United States
(12) Patent Application Publication
(10) Pub. No.: US 2011/0229682 A1
(43) Pub. Date: Sep. 22, 2011

(54) Glove fix bandage

(76) Inventor: Jian Yi Ye, Hayward, CA (US)

(21) Appl. No.: 12/728,219

(22) Filed: Mar. 21, 2010

(51) Int. Cl. B32B 25/12; A41D 19/00

(52) U.S. Cl. 428/99; 428/492

(57) ABSTRACT

A glove fix bandage is invented to reduce pollution caused by rubber wastes from unwanted gloves. This bandage has waterproof and latex surface, and its fastener portion is waterproof and flexible to wrap and fix uneven, worn surfaces on gloves.

### BACKGROUND OF THE INVENTION

1. Field of the Invention

This invention relates to bandages fixing worn gloves, more particularly, to bandages with waterproof and flexible structure to fix uneven, worn surface on gloves.

2. Description of the Related Art

Worn gloves, especially those made with rubber, are often misplaced and cause pollution to environment. Gloves that are used in kitchen areas are usually waterproof, but a small cut or worn spot may make them useless as water permeate into the gloves and cause damages from inner part of the gloves. The longer water stays inside of rubber gloves, the rubber particles start to dissolve and the gloves become more fragile. Generally, if one of a pair of gloves is damaged, the other one is useless as well. Then they are often dumped into garbage bin and cause pollution to environment.

A glove fix bandage can save a pair of gloves from situation described above. Once there is a small cut or worn area on a glove, one can wrap it with a glove fix bandage to prevent further damage, especially damage by water. If water has permeated through a worn area into a glove, one should apply one bandage wrapping worn surface and, if necessary, use a smaller size bandage fixing inner part of the glove.

This glove fix bandage is made with latex and both of its surface and bottom areas are waterproof. Its surface is waterproof with grip and allows gloves to retain its capability to hold slippery items after this bandage is wrapped. The fastener portion as shown in FIGS. 2 and 3 100 of this bandage is made with waterproof adhesive material. The adhesive surface is flexible to fit into any uneven, worn areas of gloves to prevent water from permeating through. Because many gloves are used to handle food or appliances that may be used to contain or process food, so the adhesive material used is non-toxic and safe for handling food.

For people who don't want to let others see bandages on worn gloves, they can use a transparent glove fix bandage which has all functions as regular glove fix bandage except that it is transparent.

### BRIEF DESCRIPTION OF THE DRAWINGS

FIG. 1 is top view of a glove fix bandage

FIG. 2, 3 are cross-section views of a glove fix bandage

FIG. 4 is a bottom view of a glove fix bandage

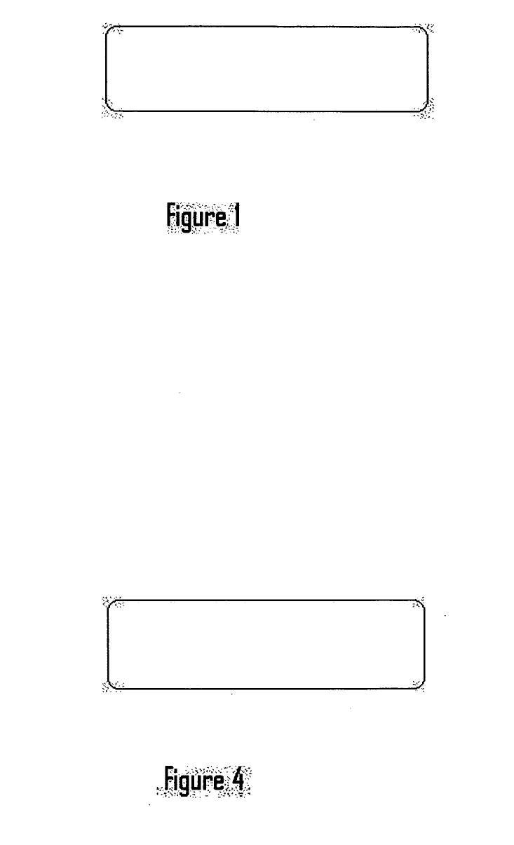

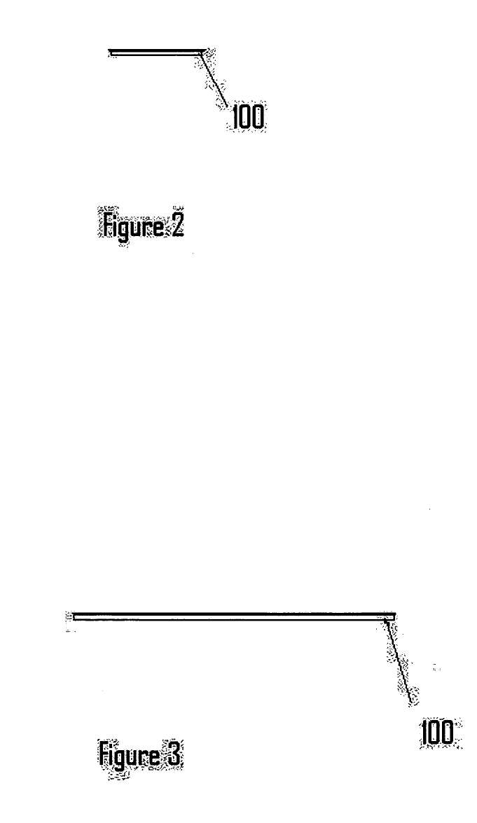

I claim:

1. A glove fix bandage has waterproof, latex, flexible surface, which can be used to wrap and fix worn surfaces on gloves made with either soft or rigid materials.

2. A bandage as defined in claim 1, wherein its fastener portion is waterproof.

3. A bandage as defined in claim 1, wherein its fastener portion is flexible to fix uneven, worn surfaces of gloves.
